(19) United States
(12) Patent Application Publication
(10) Pub. No.: US 2008/0152251 A1
(43) Pub. Date: Jun. 26, 2008

(54) Pyramidal Decomposition for Multi-Resolution Image Filtering

(75) Inventors: Raoul Florent, Ville D'Avray (FR); Mathieu Picard, Paris (FR); Christophe Samson, Le Guevin (FR)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/814,817

(22) PCT Filed: Jan. 27, 2006
(86) PCT No.: PCT/IB06/50302

§ 371 Date: Jul. 26, 2007

(30) Foreign Application Priority Data
Jan. 31, 2005 (EP) 05300076.6

(51) Int. Cl. G06K 9/40

(52) U.S. Cl. 382/260

(57) ABSTRACT

A modified Laplacian-pyramid method and system filters (340-360, 440-460) the Gaussian image at each level (31-33, 41-43) of the pyramid, and uses the filtered Gaussian image (341-361, 441-461) to produce the Laplacian-pyramid images (349-369, 449-469). The filtering of the Gaussian image is adaptive, and based at least in part on the characteristics of the Gaussian image at each stage. In one example embodiment, two filters (F1, F2) are used at each stage, and the Laplacian image (349-369) is based on a filtered version of the Gaussian image and an upsampled filtered version of a downsampling (346-366) of the Gaussian image. In another example, filter is used, and the Laplacian image (449-469) is based on the filtered version (441-461) of the Gaussian image and an upsampled downsampling (446-466) of the filtered version of the Gaussian image. By forming the Laplacian images (349-369, 449-469) from the filtered Gaussian images (341-361, 441-461), the aliasing conventionally produced by filtering the Laplacian images is substantially reduced.

This invention relates to the field of electronic systems, and in particular to an image processing method and system that filters an image at multiple resolutions.

The “Laplacian Pyramid”, as presented in “The Laplacian Pyramid as a Compact Image Code”, Peter J. Burt and Edward H. Adelson, IEEE TRANSACTIONS ON COMMUNICATIONS, VOL. COM-31, NO. 4, APRIL 1983, is commonly used to efficiently encode and transmit images, and allows for downloading images at select resolution levels, to optimize bandwidth utilization.

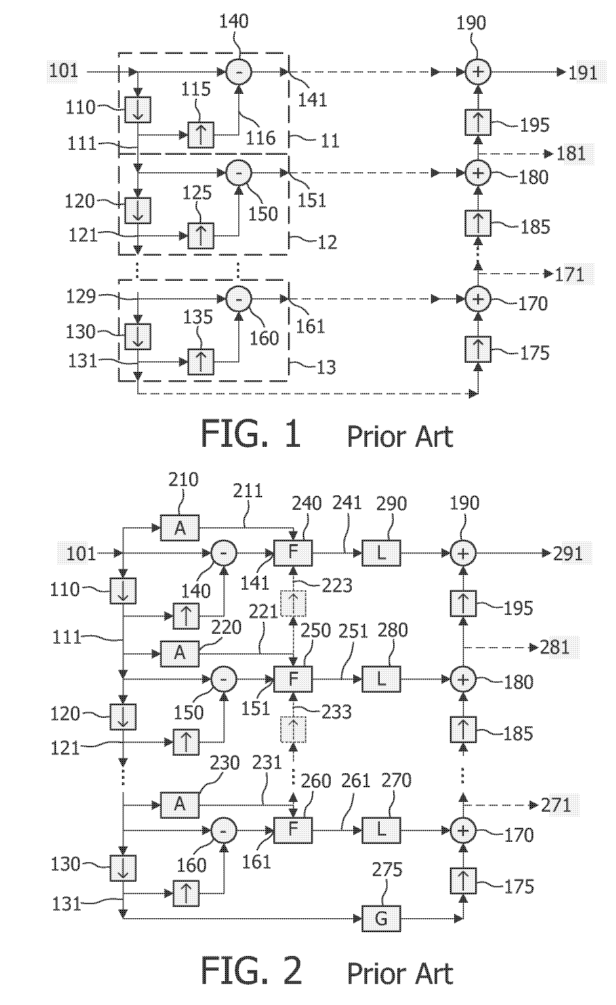

FIG. 1 illustrates the operation of a Laplacian Pyramid for encoding an image, and subsequently decoding the image. The image signal 101 is downsampled, or bandwidth limited, at 110, to produce a filtered signal 111. This filtered signal 111 is, for example, a 2:1 reduction of the image 101, and thus is half the size and half the resolution of the image 101. This filtered signal 111 is upsampled at 115 to produce a full-size image 116, but at the reduced resolution. A subtractor 140 subtracts the reduced-resolution image 116 from the original image 101, to produce an output signal 141. This output signal 141 comprises the high-frequency components, or high-resolution details, that are missing from the reduced-resolution image 116, and thus is a high-pass filtered version of the input signal 101. That is, the first stage 11 of the Laplacian Pyramid separates the input image 101 into its low-pass filtered components 111, and its high-pass filtered components 141. Of particular note, the components 111 and 141 contain sufficient information to accurately recreate the image 101.

The next stage 12 similarly separates the image 111 into a low-pass filtered, i.e. lower-resolution, image 121 and the high-pass filtered components, i.e. higher-resolution details, 151 of the image 111 that are missing from the lower-resolution image 121. Similarly, each subsequent stage provides a segregation of the prior stages image into a lower-resolution image and the higher-resolution details absent from the lower-resolution image.

The lowest-resolution image 131 of the final stage 13, and each of the higher-resolution details 161, . . . , 151, 141 contain all of the information needed to reproduce the original image 101.

A receiver/re-composer of the image 101 is illustrated in FIG. 1 by the components 170-195. An adder 170 adds the higher-resolution details 161 to an upsampled 175 copy of the lowest resolution image 131 to produce an image 171 that is equal to the input image 129 of the final stage 13. Adding the next-higher-resolution details to an upsampled copy of this image 171 will produce an image that is equal to the input image of the level above the final stage 13. Continuing in this manner, the image 181 corresponds to the image 111, and the output image 191 corresponds to the image 101. Thus, the communication of the lowest-resolution image 131 and each of the high-pass filtered components 161, . . . , 151, 141, to a receiver allows the receiver to completely reproduce the original image 101. Additionally, if the image 131 and components 161, . . . , 151, 141 are communicated sequentially, the receiver can terminate the transmission at any time, and merely produce a lower-resolution copy 171, . . . , 181 of the original image 101.

Conventionally, each of the progressively smaller down-sampled images 111, 121, 131 are termed “Gaussian-pyramid” images, and the high-pass filtered components 141, 151, . . . , 161 are termed “Laplacian-pyramid” images. As an image is low-pass filtered, sharp changes, such as edges, are softened. Alternatively stated, the Laplacian images generally contain the details related to features such as edges and other features.

Image enhancement techniques often address improving the sharpness of images. Because the Laplacian-pyramid progressively separates the details of edges and other features, Laplacian images are often used to provide image enhancement, particularly in the field of medical image diagnoses.

U.S. Pat. No. 6,173,084, “NOISE REDUCTION IN AN IMAGE”, issued 9 Jan. 2001 to Aach et al., and incorporated by reference herein, teaches filtering the Laplacian images based on the contents of the lower-resolution Laplacian images. Generally, a steep edge produces high-frequency components through many, or all, levels of a Laplacian-pyramid, whereas noise generally produces high-frequency components through only one, or a few, levels. By filtering across multiple levels of the Laplacian images, edge features are enhanced and noise effects are smoothed.

U.S. Pat. No. 6,252,931, “PROCESSING METHOD FOR AN ORIGINAL IMAGE”, issued 26 Jun. 2001 to Aach et al., and incorporated by reference herein, teaches a non-linear enhancement of the Laplacian images to enhance contrast and reduce noise. Similarly, U.S. Pat. No. 6,760,401, “APPARATUS AND METHOD FOR PROCESSING OF DIGITAL IMAGES”, issued 6 Jul. 2004 to Schmitz et al., and U.S. Patent Application Publication 2004/0101207, published 27 May 2004 for Langan, each teach a modification of the Laplacian images to enhance the input image and/or reduce the noise. For ease of reference, image enhancement as used herein optionally includes noise reduction.

FIG. 2 illustrates a general form of a processor, or process, that provides image enhancement by modifying the Laplacian images 141, 151, . . . , 161 corresponding to an input image 101. The modification is represented by filters 240, 250, . . . , 260, which are generally configured as adaptive filters, with adaptation components 210, 220, . . . , 230 that provide the filter coefficients. In some embodiments, the filters may also provide filtering that is based on the characteristics of lower-resolution images. Also illustrated is an optional transform “L” 290, 280, . . . 270 between the filtered Laplacian images 241, 251, . . . , 261 and the receiver/re-composer components 190, 180, . . . , 170, and an optional transform “G” 275 between the downsampled Gaussian image 131 and the upsampler 175. These transforms represent simple operations on the filtered Laplacian images, such as normalizing the amplitudes of the images or otherwise facilitating the interface between the encoded images and the receiver/re-composer. These optional transforms are not related to this invention, and will not be further discussed.

The operation of the process of FIG. 2 can be described mathematically as:

Bₖ=(1−UD)Hₖ

Hₖ₊₁=DHₖ

Cₖ=AHₖ

Dₖ=UADHₖ

Rₖ=F[Bₖ,Cₖ,Dₖ]=F[(1−UD)Hₖ,AHₖ,UADHₖ]

where k represents the pyramid level, Hₖ represents the input image (101, 111, 121, . . . 131) at each level, D (110, 120, . . . , 130) represents downsampling, U represents upsampling, Bₖ (141, 151, . . . , 161) represents the Laplacian images, A (210, 220, . . . , 230) represents the transform used to obtain the adaptive filter coefficients Cₖ (211, 221, . . . , 231), Dₖ (223, 233, . . . ) represents the filter coefficients based on lower-resolution images, F (240, 250, . . . , 260) represents the filter function, and Rₖ (241, 251, . . . , 261) represents the output filtered Laplacian image.

A common problem with the conventional image enhancement processes, however, is the aliasing that is produced by the upsampling and downsampling functions. In the unmodified Laplacian pyramid of FIG. 1, the aliasing effects are cancelled by the complementary operations in the receiver/re-composer. However, when filtering is applied to each Laplacian image, the filtering action on the aliased areas prevents proper aliasing cancellation in the receiver/re-composer.

Another common problem is the fact that the adaptation coefficients are generally based on the Gaussian images, where noise can be more easily measured, whereas the adaptation is performed on the Laplacian images. This separation requires a determination of a proper transformation between the different signal characteristics of the Gaussian and Laplacian images, and increases the adaptation process's susceptibility to noise-induced errors.

It is an object of this invention to improve and/or simplify the adaptive filtering process in a filtered Laplacian pyramid. It is a further object of this invention to reduce the aliasing effects in a filtered Laplacian pyramid.

These objects and others are achieved by a modified Laplacian-pyramid method and system that filters the Gaussian image, and uses the filtered Gaussian image to produce the Laplacian-pyramid images. The filtering of the Gaussian image is adaptive, and based at least in part on the characteristics of the Gaussian image at each stage. In one example embodiment, two filters are used at each stage, and the Laplacian image is based on a filtered version of the Gaussian image and an upsampled filtered version of a downsampling of the Gaussian image. In another example, one filter is used, and the Laplacian image is based on the filtered version of the Gaussian image and an upsampled downsampling of the filtered version of the Gaussian image.

The invention is explained in further detail, and by way of example, with reference to the accompanying drawings wherein:

FIG. 1 illustrates an example block diagram of a Laplacian-pyramid image encoder and decoder.

FIG. 2 illustrates an example block diagram of an image processor based on a Laplacian-pyramid encoding of an image.

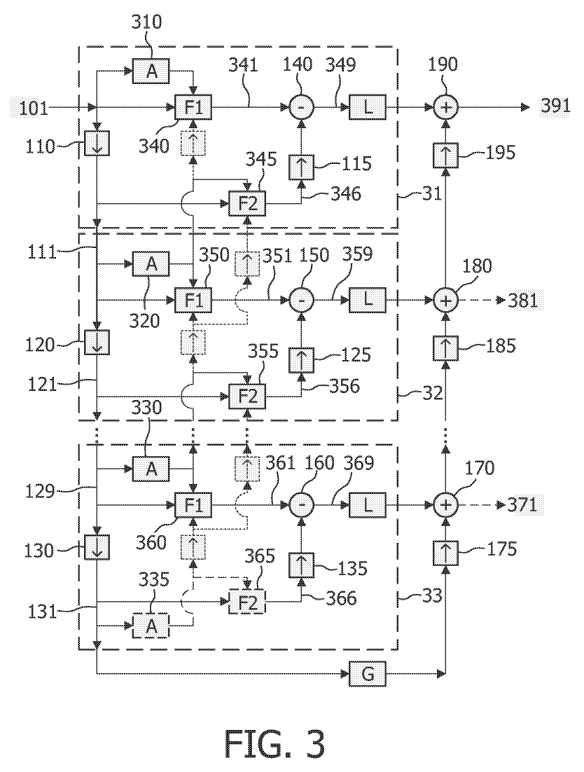

FIG. 3 illustrates an example block diagram of an image processor based on a modified Laplacian-pyramid encoding of an image in accordance with this invention.

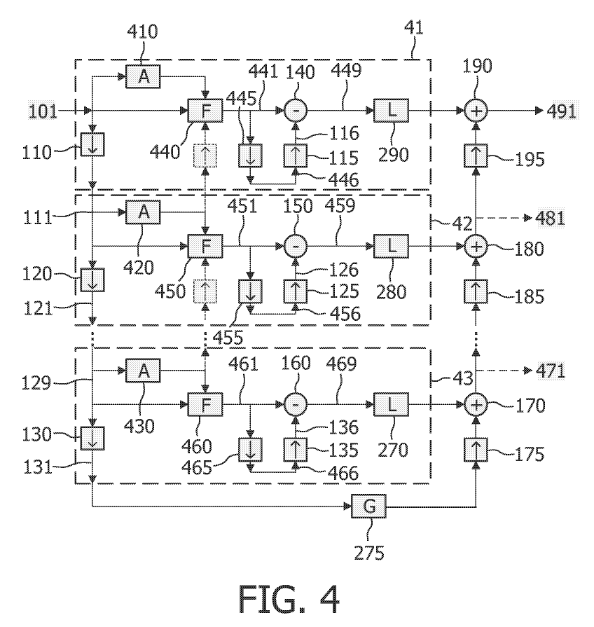

FIG. 4 illustrates another example block diagram of an image processor based on a modified Laplacian-pyramid encoding of an image in accordance with this invention.

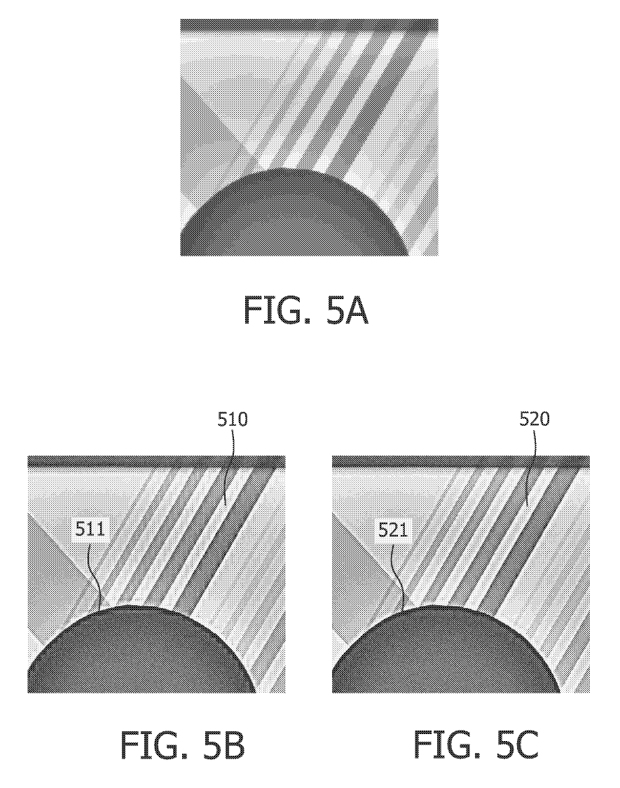

FIG. 5A illustrates an example input image.

FIG. 5B illustrates an example sharpening of the input image using a conventional prior art Laplacian-pyramid filter.

FIG. 5C illustrates an example sharpening of the input image using the modified Laplacian-pyramid filter of this invention.

Throughout the drawings, the same reference numeral refers to the same element, or an element that performs substantially the same function. The drawings are included for illustrative purposes and are not intended to limit the scope of the invention.

FIG. 3 illustrates an example block diagram of an image processor based on a modified Laplacian-pyramid encoding of an image in accordance with this invention. In this embodiment, the filter operation at each stage 31, 32, . . . , 33 of the image processor is partitioned into two filters, F1 340, 350, . . . , 360, and F2 345, 355, . . . , 365. The filter F1 is configured to filter the input (Gaussian) image 101, 111, 121, . . . , 129 at each stage 31, 32, . . . , 33, and the filter F2 is configured to filter the downsampled image (111, 121, . . . 129) that forms the input to each subsequent stage 32, . . . , 33.

The filter F 1 provides the same functionality as the filter F of FIG. 2, except that it is applied to the baseband Gaussian image, instead of the band-pass Laplacian image. The filter F2 can be considered to be a downsampled version of F1. That is, for example, if the extent of the filter F1 can be derived from a scale parameter σ, the extent of the filter F2 can be derived from a scale parameter σ/2.

Preferably, the filters F1, F2 are adaptive filters, and provide a filtering effect that is based on coefficients that are provided by an adaptation component 310, 320, . . . , 330, based on characteristics of each of the Gaussian images. Optionally, as in conventional systems, the filtering effects can also be based upon the characteristics of subsequent lower-resolution stages in the pyramid. Because the filter coefficients that are determined at the Gaussian image level are applied to the corresponding Gaussian image, the aforementioned transformation between the different signal characteristics of the Gaussian and Laplacian images of FIG. 2 does not need to be determined and performed, and the adaptation process's susceptibility to noise-induced errors is reduced.

The band-pass Laplacian images 349, 359, . . . , 369 of this embodiment are formed at each stage 31, 32, . . . , 33 by subtracting an upsampling of the filtered downsampled images 346, 356, . . . , 366 from the filtered Gaussian image 341, 351, . . . , 361. Because the creation of the Laplacian images occurs after the filtering process, the aliasing produced by this embodiment is substantially less than the aliasing that is produced by filtering the created Laplacian images as in conventional Laplacian-pyramid image processors.

The operation of the process of FIG. 3 can be described mathematically as:

Hₖ₊₁=DHₖ

Cₖ=AHₖ

Dₖ=UADHₖ

Rₖ=F1[Hₖ,Cₖ,Dₖ]−UF2[DHₖ,DCₖ,DDₖ]

or, equivalently,

Rₖ=F1[Hₖ,Cₖ,Dₖ]−UF2[Hₖ₊₁,Cₖ₊₁,Dₖ₊₁],

where k represents the pyramid level, Hₖ represents the input image (101, 111, 121, . . . 131) at each level, D represents downsampling, U represents upsampling, A (310, 320, . . . , 330) represents the transform used to obtain the filter coefficients Cₖ, Dₖ represents the filter coefficients based on lower-resolution images, F1 (340, 350, . . . , 360) and F2 (345, 355, . . . , 365) represents the filter functions, and Rₖ (349, 359, . . . , 369) represents the modified Laplacian images based on the filtered input images.

FIG. 4 illustrates another example block diagram of an image processor based on a modified Laplacian-pyramid encoding of an image in accordance with this invention. In this embodiment, a single filter F 440, 450, . . . , 460 is used to filter the baseband Gaussian image 101, 111, . . . , 129. The filter F provides the same filter function as the filter F in the example embodiment of FIG. 2, but the filtering is applied to the baseband Gaussian image, rather than the Laplacian image.

The filtered Gaussian image 441, 451, . . . , 461 at each stage 41, 42, . . . , 43 is downsampled 445, 455, . . . , 465 to produce a downsampled filtered image 446, 456, . . . , 466. The band-pass Laplacian image 449, 459, . . . , 469 at each stage 41, 42, . . . , 43 is produced by subtracting an upsampling 115, 125, . . . , 135 of the downsampled filter image 446, 456, . . . , 466 from the filtered Gaussian image 441, 451, . . . , 461.

As in the embodiment of FIG. 3, because the filtering F is performed on the same Gaussian image from which the adaptation component 410, 420, . . . 430 derives the filter coefficients, the aforementioned transformation from Gaussian characteristics to Laplacian coefficients is avoided, and the susceptibility of the adaptive filter process to noise-induced errors is reduced. Also as in the embodiment of FIG. 3, because the band-pass Laplacian image 449, 459, . . . , 469 is formed from the filtered baseband Gaussian images 441, 451, . . . , 461, the aliasing produced by the embodiment of FIG. 4 is substantially less than the aliasing produced by the conventional embodiment of FIG. 2. Additionally, the embodiment of FIG. 4 has approximately the same level of computational complexity as the conventional embodiment of FIG. 2.

The operation of the process of FIG. 4 can be described mathematically, using the symbols of FIG. 3, as:

Hₖ₊₁=DHₖ

Cₖ=AHₖ

Dₖ=UADHₖ

Rₖ=F[Hₖ,Cₖ,Dₖ]−UDF[Hₖ,Cₖ,Dₖ]=(1−UD)F[Hₖ, Cₖ,Dₖ].

FIGS. 5B and 5C illustrate a comparison of an example image processing of an input image 5A using a conventional Laplacian-pyramid image process (FIG. 5B) and a modified Laplacian-pyramid image process (FIG. 5B) of this invention. The example illustrates a sharpening process applied to the input image 5A. As can be seen, the output 5B of the conventional image process exhibits artifacts 510, 511 produced by the aliasing effects of the post-Laplacian filtering of the conventional process. The artifacts 520, 521 in the output 5C of the embodiment of FIG. 4 of this invention are substantially reduced.

The foregoing merely illustrates the principles of the invention. It will thus be appreciated that those skilled in the art will be able to devise various arrangements which, although not explicitly described or shown herein, embody the principles of the invention and are thus within the spirit and scope of the following claims.

In interpreting these claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) each of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise;

h) no specific sequence of acts is intended to be required unless specifically indicated; and

i) the term “plurality of” an element includes two or more of the claimed element, and does not imply any particular range of number of elements; that is, a plurality of elements can be as few as two elements.

### Pyramidal Decomposition for Multi-Resolution Image Fultering

This invention relates to the field of electronic systems, and in particular to an image processing method and system that filters an image at multiple resolutions.

The “Laplacian Pyramid”, as presented in “The Laplacian Pyramid as a Compact Image Code”, Peter J. Burt and Edward H. Adelson, IEEE TRANSACTIONS ON COMMUNICATIONS, VOL. COM-31, NO. 4, APRIL 1983, is commonly used to efficiently encode and transmit images, and allows for downloading images at select resolution levels, to optimize bandwidth utilization.

FIG. 1 illustrates the operation of a Laplacian Pyramid for encoding an image, and subsequently decoding the image. The image signal 101 is downsampled, or bandwidth limited, at 110, to produce a filtered signal 111. This filtered signal 111 is, for example, a 2:1 reduction of the image 101, and thus is half the size and half the resolution of the image 101. This filtered signal 111 is upsampled at 115 to produce a full-size image 116, but at the reduced resolution. A subtractor 140 subtracts the reduced-resolution image 116 from the original image 101, to produce an output signal 141. This output signal 141 comprises the high-frequency components, or high-resolution details, that are missing from the reduced-resolution image 116, and thus is a high-pass filtered version of the input signal 101. That is, the first stage 11 of the Laplacian Pyramid separates the input image 101 into its low-pass filtered components 111, and its high-pass filtered components 141. Of particular note, the components 111 and 141 contain sufficient information to accurately recreate the image 101.

The next stage 12 similarly separates the image 111 into a low-pass filtered, i.e. lower-resolution, image 121 and the high-pass filtered components, i.e. higher-resolution details, 151 of the image 111 that are missing from the lower-resolution image 121. Similarly, each subsequent stage provides a segregation of the prior stages image into a lower-resolution image and the higher-resolution details absent from the lower-resolution image.

The lowest-resolution image 131 of the final stage 13, and each of the higher-resolution details 161, . . . , 151, 141 contain all of the information needed to reproduce the original image 101.

A receiver/re-composer of the image 101 is illustrated in FIG. 1 by the components 170-195. An adder 170 adds the higher-resolution details 161 to an upsampled 175 copy of the lowest resolution image 131 to produce an image 171 that is equal to the input image 129 of the final stage 13. Adding the next-higher-resolution details to an upsampled copy of this image 171 will produce an image that is equal to the input image of the level above the fmal stage 13. Continuing in this manner, the image 181 corresponds to the image 111, and the output image 191 corresponds to the image 101. Thus, the communication of the lowest-resolution image 131 and each of the high-pass filtered components 161, . . . , 151, 141, to a receiver allows the receiver to completely reproduce the original image 101. Additionally, if the image 131 and components 161, . . . , 151, 141 are communicated sequentially, the receiver can terminate the transmission at any time, and merely produce a lower-resolution copy 171, . . . , 181 of the original image 101.

Conventionally, each of the progressively smaller down-sampled images 111, 121, 131 are termed “Gaussian-pyramid” images, and the high-pass filtered components 141, 151, . . . , 161 are termed “Laplacian-pyramid” images. As an image is low-pass filtered, sharp changes, such as edges, are softened. Alternatively stated, the Laplacian images generally contain the details related to features such as edges and other features.

Image enhancement techniques often address improving the sharpness of images. Because the Laplacian-pyramid progressively separates the details of edges and other features, Laplacian images are often used to provide image enhancement, particularly in the field of medical image diagnoses.

U.S. Pat. No. 6,173,084, “NOISE REDUCTION IN AN IMAGE”, issued 9 Jan. 2001 to Aach et al., and incorporated by reference herein, teaches filtering the Laplacian images based on the contents of the lower-resolution Laplacian images. Generally, a steep edge produces high-frequency components through many, or all, levels of a Laplacian-pyramid, whereas noise generally produces high-frequency components through only one, or a few, levels. By filtering across multiple levels of the Laplacian images, edge features are enhanced and noise effects are smoothed.

U.S. Pat. No. 6,252,931, “PROCESSING METHOD FOR AN ORIGINAL IMAGE”, issued 26 Jun. 2001 to Aach et al., and incorporated by reference herein, teaches a non-linear enhancement of the Laplacian images to enhance contrast and reduce noise. Similarly, U.S. Pat. No. 6,760,401, “APPARATUS AND METHOD FOR PROCESSING OF DIGITAL IMAGES”, issued 6 Jul. 2004 to Schmitz et al., and U.S. Patent Application Publication 2004/0101207, published 27 May 2004 for Langan, each teach a modification of the Laplacian images to enhance the input image andlor reduce the noise. For ease of reference, image enhancement as used herein optionally includes noise reduction.

FIG. 2 illustrates a general form of a processor, or process, that provides image enhancement by modifying the Laplacian images 141, 151, . . . , 161 corresponding to an input image 101. The modification is represented by filters 240, 250, . . . , 260, which are generally configured as adaptive filters, with adaptation components 210, 220, . . . , 230 that provide the filter coefficients. In some embodiments, the filters may also provide filtering that is based on the characteristics of lower-resolution images. Also illustrated is an optional transform “L” 290, 280, . . . 270 between the filtered Laplacian images 241, 251, . . . , 261 and the receiver/re-composer components 190, 180, . . . , 170, and an optional transform “G” 275 between the downsampled Gaussian image 131 and the upsampler 175. These transforms represent simple operations on the filtered Laplacian images, such as normalizing the amplitudes of the images or otherwise facilitating the interface between the encoded images and the receiver/re-composer. These optional transforms are not related to this invention, and will not be further discussed.

The operation of the process of FIG. 2 can be described mathematically as:

Bₖ=(1−UD)Hₖ

Hₖ₊₁=DHₖ

Cₖ=AHₖ

Dₖ=UADHₖ

Rₖ=F[Bₖ,Cₖ,Dₖ]=F[(1−UD)Hₖ,AHₖ,UADHₖ]

where k represents the pyramid level, Hₖ represents the input image (101, 111, 121, . . . 131) at each level, D (110, 120, . . . , 130) represents downsampling, U represents upsampling, Bₖ (141, 151, . . . , 161) represents the Laplacian images, A (210, 220, . . . , 230) represents the transform used to obtain the adaptive filter coefficients Cₖ (211, 221, . . . , 231), Dₖ (223, 233, . . . ) represents the filter coefficients based on lower-resolution images, F (240, 250, . . . , 260) represents the filter function, and Rₖ (241, 251, . . . , 261) represents the output filtered Laplacian image.

A common problem with the conventional image enhancement processes, however, is the aliasing that is produced by the upsampling and downsampling functions. In the unmodified Laplacian pyramid of FIG. 1, the aliasing effects are cancelled by the complementary operations in the receiver/re-composer. However, when filtering is applied to each Laplacian image, the filtering action on the aliased areas prevents proper aliasing cancellation in the receiver/re-composer.

Another common problem is the fact that the adaptation coefficients are generally based on the Gaussian images, where noise can be more easily measured, whereas the adaptation is performed on the Laplacian images. This separation requires a determination of a proper transformation between the different signal characteristics of the Gaussian and Laplacian images, and increases the adaptation process's susceptibility to noise-induced errors.

It is an object of this invention to improve and/or simplify the adaptive filtering process in a filtered Laplacian pyramid. It is a further object of this invention to reduce the aliasing effects in a filtered Laplacian pyramid.

These objects and others are achieved by a modified Laplacian-pyramid method and system that filters the Gaussian image, and uses the filtered Gaussian image to produce the Laplacian-pyramid images. The filtering of the Gaussian image is adaptive, and based at least in part on the characteristics of the Gaussian image at each stage. In one example embodiment, two filters are used at each stage, and the Laplacian image is based on a filtered version of the Gaussian image and an upsampled filtered version of a downsampling of the Gaussian image. In another example, one filter is used, and the Laplacian image is based on the filtered version of the Gaussian image and an upsampled downsampling of the filtered version of the Gaussian image.

The invention is explained in further detail, and by way of example, with reference to the accompanying drawings wherein:

FIG. 1 illustrates an example block diagram of a Laplacian-pyramid image encoder and decoder.

FIG. 2 illustrates an example block diagram of an image processor based on a Laplacian-pyramid encoding of an image.

FIG. 3 illustrates an example block diagram of an image processor based on a modified Laplacian-pyramid encoding of an image in accordance with this invention.

FIG. 4 illustrates another example block diagram of an image processor based on a modified Laplacian-pyramid encoding of an image in accordance with this invention.

FIG. 5A illustrates an example input image.

FIG. 5B illustrates an example sharpening of the input image using a conventional prior art Laplacian-pyramid filter.

FIG. 5C illustrates an example sharpening of the input image using the modified Laplacian-pyramid filter of this invention.

Throughout the drawings, the same reference numeral refers to the same element, or an element that performs substantially the same function. The drawings are included for illustrative purposes and are not intended to limit the scope of the invention.

FIG. 3 illustrates an example block diagram of an image processor based on a modified Laplacian-pyramid encoding of an image in accordance with this invention. In this embodiment, the filter operation at each stage 31, 32, . . . , 33 of the image processor is partitioned into two filters, F1 340, 350, . . . , 360, and F2 345, 355, . . . , 365. The filter F1 is configured to filter the input (Gaussian) image 101, 111, 121, . . . , 129 at each stage 31, 32, . . . , 33, and the filter F2 is configured to filter the downsampled image (111, 121, . . . 129) that forms the input to each subsequent stage 32, . . . , 33.

The filter F1 provides the same functionality as the filter F of FIG. 2, except that it is applied to the baseband Gaussian image, instead of the band-pass Laplacian image. The filter F2 can be considered to be a downsampled version of F1. That is, for example, if the extent of the filter F1 can be derived from a scale parameter σ, the extent of the filter F2 can be derived from a scale parameter σ/2.

Preferably, the filters F1, F2 are adaptive filters, and provide a filtering effect that is based on coefficients that are provided by an adaptation component 310, 320, . . . , 330, based on characteristics of each of the Gaussian images. Optionally, as in conventional systems, the filtering effects can also be based upon the characteristics of subsequent lower-resolution stages in the pyramid. Because the filter coefficients that are determined at the Gaussian image level are applied to the corresponding Gaussian image, the aforementioned transformation between the different signal characteristics of the Gaussian and Laplacian images of FIG. 2 does not need to be determined and performed, and the adaptation process's susceptibility to noise-induced errors is reduced.

The band-pass Laplacian images 349, 359, . . . , 369 of this embodiment are formed at each stage 31, 32, . . . , 33 by subtracting an upsampling of the filtered downsampled images 346, 356, . . . , 366 from the filtered Gaussian image 341, 351, . . . , 361. Because the creation of the Laplacian images occurs after the filtering process, the aliasing produced by this embodiment is substantially less than the aliasing that is produced by filtering the created Laplacian images as in conventional Laplacian-pyramid image processors.

The operation of the process of FIG. 3 can be described mathematically as:

Hₖ₊₁=DHₖ

Cₖ=AHₖ

Dₖ=UADHₖ

Rₖ=F1[Hₖ,Cₖ,Dₖ]−UF2[DHₖ,DCₖ,DDₖ]

or, equivalently,

Rₖ=F1[Hₖ,Cₖ,Dₖ]−UF2[Hₖ₊₁,Cₖ₊₁,Dₖ₊₁],

where k represents the pyramid level, Hₖ represents the input image (101, 111, 121, . . . 131) at each level, D represents downsampling, U represents upsampling, A (310, 320, . . . , 330) represents the transform used to obtain the filter coefficients Cₖ, Dₖ represents the filter coefficients based on lower-resolution images, F1 (340, 350, . . . , 360) and F2 (345, 355, . . . , 365) represents the filter functions, and Rₖ (349, 359, . . . , 369) represents the modified Laplacian images based on the filtered input images.

FIG. 4 illustrates another example block diagram of an image processor based on a modified Laplacian-pyramid encoding of an image in accordance with this invention. In this embodiment, a single filter F 440, 450, . . . , 460 is used to filter the baseband Gaussian image 101, 111, . . . , 129. The filter F provides the same filter function as the filter F in the example embodiment of FIG. 2, but the filtering is applied to the baseband Gaussian image, rather than the Laplacian image.

The filtered Gaussian image 441, 451, . . . , 461 at each stage 41, 42, . . . , 43 is downsampled 445, 455, . . . , 465 to produce a downsampled filtered image 446, 456, . . . , 466. The band-pass Laplacian image 449, 459, . . . , 469 at each stage 41, 42, . . . , 43 is produced by subtracting an upsampling 115, 125, . . . , 135 of the downsampled filter image 446, 456, . . . , 466 from the filtered Gaussian image 441, 451, . . . , 461.

As in the embodiment of FIG. 3, because the filtering F is performed on the same Gaussian image from which the adaptation component 410, 420, ... 430 derives the filter coefficients, the aforementioned transformation from Gaussian characteristics to Laplacian coefficients is avoided, and the susceptibility of the adaptive filter process to noise-induced errors is reduced. Also as in the embodiment of FIG. 3, because the band-pass Laplacian image 449, 459, . . . , 469 is formed from the filtered baseband Gaussian images 441, 451, . . . , 461, the aliasing produced by the embodiment of FIG. 4 is substantially less than the aliasing produced by the conventional embodiment of FIG. 2. Additionally, the embodiment of FIG. 4 has approximately the same level of computational complexity as the conventional embodiment of FIG. 2.

The operation of the process of FIG. 4 can be described mathematically, using the symbols of FIG. 3, as:

Hₖ₊₁=DHₖ

Cₖ=AHₖ

Dₖ=UADHₖ

Rₖ=F[Hₖ,Cₖ,Dₖ]−UDF[Hₖ,Cₖ,Dₖ]=(1−UD)F[Hₖ,Cₖ,Dₖ].

FIGS. 5B and 5C illustrate a comparison of an example image processing of an input image 5A using a conventional Laplacian-pyramid image process (FIG. 5B) and a modified Laplacian-pyramid image process (FIG. 5B) of this invention. The example illustrates a sharpening process applied to the input image 5A. As can be seen, the output 5B of the conventional image process exhibits artifacts 510, 511 produced by the aliasing effects of the post-Laplacian filtering of the conventional process. The artifacts 520, 521 in the output 5C of the embodiment of FIG. 4 of this invention are substantially reduced.

The foregoing merely illustrates the principles of the invention. It will thus be appreciated that those skilled in the art will be able to devise various arrangements which, although not explicitly described or shown herein, embody the principles of the invention and are thus within the spirit and scope of the following claims.

In interpreting these claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) each of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise;

h) no specific sequence of acts is intended to be required unless specifically indicated; and

i) the term “plurality of” an element includes two or more of the claimed element, and does not imply any particular range of number of elements; that is, a plurality of elements can be as few as two elements.

1. An image processing system comprising:
a plurality of stages (31-33, 41-43), each stage of the plurality of stages (31-33, 41-43) including:
a downsampler (110, 120, 130) that is configured to receive an input image (101, 111, 129) and to produce therefrom a first downsampled image (111, 121, 131) that is provided as the input image of a subsequent stage (32-33, 42-43),
a filter (340-360, 440-460) that is configured to filter the input image (101, 111, 129) and to produce therefrom a filtered image (341-361, 441-461),
an upsampler (115, 125, 135) that is configured to receive a second downsampled image (346-366, 446-466) and to provide therefrom an upsampled image (116, 126, 136), and
a subtractor (140, 150, 160) that is configured to subtract the upsampled image (116, 126, 136) from the filtered image (341-361, 441-461), to provide therefrom a Laplacian image (349-369, 449-469) based on the filtered image (341-361, 441-461).

2. The image processing system of claim 1, wherein
each stage further includes
a second filter (345-365) that is configured to filter the first downsampled image (111-131) and to produce therefrom the second downsampled image (346-366, 446-466).

3. The image processing system of claim 1, wherein
each stage further includes
a second downsampler (445-465) that is configured to receive the filtered image (441-461) and to produce therefrom the second downsampled image (446-466).

4. The image processing system of claim 1, wherein
each stage further includes
an adaptation component (310-330, 410-430) that is configured to determine coefficients for use by the filter (340-360, 440-460), based on the input image (101, 111, 129).

5. The image processing system of claim 1, wherein
the filter (340-360, 440-460) is further configured to filter the input image (101, 111, 129) based on one or more characteristics of the first downsampled image (111, 121, 131).

6. The image processing system of claim 1, wherein
the filter (340-360, 440-460) at at least one stage of the plurality of stages (31-33, 41-43) is further configured to filter the input image (101, 111, 129) based on one or more characteristics of one or more of the input images (111, 129) at subsequent stages (32-33, 42-43) of the plurality of stages (31-33, 41-43).

7. The image processing system of claim 1, further including
a re-composer that is configured to receive images corresponding to the Laplacian image (349-369, 449-469) from each of the stages (31-33, 41-43), and the first downsampled image of a last stage (33, 43) of the plurality of stages (31-33, 41-43), and to produce therefrom an output image (171, 181, 191).

8. A method of processing an image, comprising:
downsampling (110) an input image (101) to produce a first downsampled image (111) at a first stage (31, 41) of a plurality of stages (31-33, 41-43) that forms an input image (111) to a second stage (32, 42) of the plurality of stages (31-33, 41-43);
filtering (340, 440) the input image (101) to produce a filtered image (341, 441);
upsampling (115) a second downsampled image (346, 446) to provide an upsampled image (116); and
subtracting (140) the upsampled image (116) from the filtered image (341, 441) to produce a Laplacian image (349, 449) based on the filtered image (341, 441).

9. The method of claim 8, further including:
downsampling (120) the input image (111) of the second stage (32, 42) to produce a first downsampled image (121) at the second stage (32, 42) that forms an input image (121) to a third stage of the plurality of stages (31-33, 41-43);
filtering (350, 450) the input image (111) of the second stage (32, 42) to produce a filtered image (342, 442) at the second stage (32, 42);
upsampling (125) a second downsampled image (356, 456) at the second stage (32, 42) to provide an upsampled image (126) at the second stage (32, 42); and
subtracting (150) the upsampled image (126) at the second stage (32, 42) from the filtered image (342, 442) at the second stage (32, 42) to produce a Laplacian image (359, 459) based on the filtered image (342, 442) at the second stage (32, 42).

10. The method of claim 9, further including:
repeating the downsampling (130), filtering (360), upsampling (135), and subtracting (160) at the third and subsequent stages (33, 43) of the plurality of stages (31-33, 41-43).

11. The method of claim 8, further including
filtering (345, 355, 365) the first downsampled image (111, 121, 131) at each stage of the plurality of stages (31-33) to produce the second downsampled image (346-366) at each stage.

12. The method of claim 8, further including
downsampling (445-465) the filtered image (441-461) at each stage of the plurality of stages (41-43) to produce the second downsampled image (446-466) at each stage.

13. The method of claim 8, further including
determining (310-330, 410-430) coefficients the filtering at each stage of the plurality of stages (31-33, 41-43), based on the input image (101, 111, 129) at each stage.

14. The method of claim 13, further including
determining additional coefficients for the filtering (440-460) at each stage, based on the first downsampled image (111 -131) at each stage.

15. The method of claim 13, further including
determining additional coefficients for the filtering (440-460) at at least one stage (31, 41), based on one or more of the input images (111, 129) at one or more of the other stages (32-33, 42-43) of the plurality of stages (31-33, 41-43).

16. The method of claim 8, further including
recomposing an output image (141, 181, 191), based on images corresponding to the Laplacian image (349-369, 449-469) at one or more stage, and the first downsampled image (131) of a last stage (33, 43) of the plurality of stages (31-33, 41-43).
